(19) United States
(12) Patent Application Publication
(10) Pub. No.: US 2026/0168882 A1
(43) Pub. Date: Jun. 18, 2026

(54) LEAKAGE DETECTION DEVICE

(71) Applicant: SMC CORPORATION, Tokyo (JP)

(72) Inventors: Koichi KATSUMATA, Tsukubamirai-shi (JP); Yuta OSHIMA, Tsukubamirai-shi (JP)

(73) Assignee: SMC CORPORATION, Tokyo (JP)

(21) Appl. No.: 18/993,304

(22) PCT Filed: Apr. 5, 2023
(86) PCT No.: PCT/JP2023/014116

§ 371 Date: Jan. 10, 2025

(30) Foreign Application Priority Data
Jul. 19, 2022 (JP) 2022-114719

(51) Int. Cl. G01M 3/24

(52) U.S. Cl. CPC G01M 3/243

(57) ABSTRACT

A leakage detection device for detecting leakage of compressed gas includes a microphone that collects an ultrasonic signal which is converted into an electrical signal and outputted. Lock-in amplifiers extract one of the electrical signals having a specific frequency corresponding to a leakage and a calculation circuit calculates a physical amount corresponding to an amplitude value of the signal having the specific frequency. A notification device provides a notification to a user depending on the physical amount calculated by the calculation circuit.

### TECHNICAL FIELD

The present invention relates to a leakage detection device.

### BACKGROUND ART

JP H11-142279 A discloses an ultrasound leakage inspection device having a narrowband band-pass filter. The band-pass filter passes only the frequency band of ultrasonic wave generated by leakage. The ultrasound leakage inspection device detects leakage locations where compressed gas is leaking using signals passed through the band-pass filter.

### SUMMARY OF THE INVENTION

It is difficult to narrowband a band-pass filter. Therefore, according to the disclosure of JP H11-142279 A, the band-pass filter passes signals in not only the frequency band of the ultrasonic wave generated by leakage but also a peripheral frequency band. This causes a problem that the leakage position of compressed gas cannot be detected with high accuracy.

The present invention has the object of solving the aforementioned problems.

A leakage detection device for detecting leakage of compressed gas includes a microphone that collects an ultrasonic signal, converts the ultrasonic signal into an electric signal, and outputs the electric signal; a lock-in amplifier that extracts a signal with a specific frequency corresponding to the leakage, based on the electric signal; a calculation circuit that calculates a physical quantity corresponding to an amplitude value of the signal with the specific frequency; and a notification device that notifies a user in accordance with the physical quantity calculated by the calculation circuit.

According to the present invention, the leakage location of compressed gas can be detected with high accuracy.

The above objects, features and advantages will be readily understood from the following description of the embodiments, which will be described with reference to the accompanying drawings.

### BRIEF DESCRIPTION OF DRAWINGS

FIG. 1 is a diagram illustrating how a leakage detection device according to an embodiment detects leakage of compressed gas from a pipe;

FIG. 2 is a block diagram schematically illustrating a configuration of a leakage detection device along a flow of signal processing;

FIG. 3 shows time charts showing switching periods of switches of the first and second lock-in amplifiers, respectively;

FIG. 4 is a graph illustrating an amplitude value for each frequency component extracted by each of the first second lock-in amplifiers;

FIG. 5 is a diagram illustrating an overall configuration of a leakage detection device;

FIG. 6 is a flowchart showing a processing procedure of vibration control processing performed by a vibration control circuit; and

FIG. 7 is a flowchart showing a processing procedure of display control processing performed by a display control circuit.

### DETAILED DESCRIPTION OF THE INVENTION

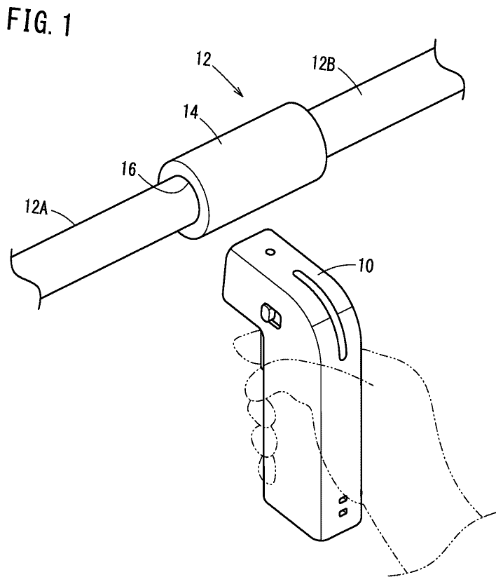

FIG. 1 is a diagram illustrating how a leakage detection device 10 according to an embodiment detects leakage of compressed gas from a pipe 12. The pipe 12 illustrated in FIG. 1 includes two pipe components 12A, 12B and a joint 14. The two pipe components 12A and 12B are connected to each other via the joint 14.

Compressed gas flows in the pipe 12. There are cases where compressed gas leaks from the pipe 12 to the outside. In the example shown in FIG. 1, there is a compressed gas leakage location 16 at a connection portion between the pipe component 12A and the joint 14. To detect compressed gas leakage, the leakage location 16 needs to be identified. It is often difficult to identify the leakage location 16 with the naked eye. In addition, in some cases, it will be difficult to identify the leakage location 16 with the naked eye because the compressed gas leaks in a narrow space within a device to which the compressed gas is supplied, for example.

When compressed gas leaks, an ultrasonic signal in a frequency band including a specific frequency F0 is generated. Therefore, the leakage detection device 10 according to the present embodiment collects ultrasonic signals. The leakage detection device 10 notifies a user according to an amplitude value A0 of a signal having a specific frequency F0 extracted from the collected ultrasonic signals. The specific frequency F0 is, for example, 40 kHz.

The user carries the leakage detection device 10. To check for compressed gas leakage, a user grasps the leakage detection device 10 and brings the leakage detection device 10 close to the pipe 12. The user moves the leakage detection device 10 to follow the pipe 12 near the pipe 12. When the leakage detection device 10 approaches the compressed gas leakage location 16, an amplitude value of an extracted signal having the specific frequency F0 increases. The user is informed according to the amplitude value, whereby the user can identify the leakage location 16. The compressed gas may leak from a compressed gas flow path other than the pipe 12. The leakage detection device 10 can be applied to a flow path other than the pipe 12.

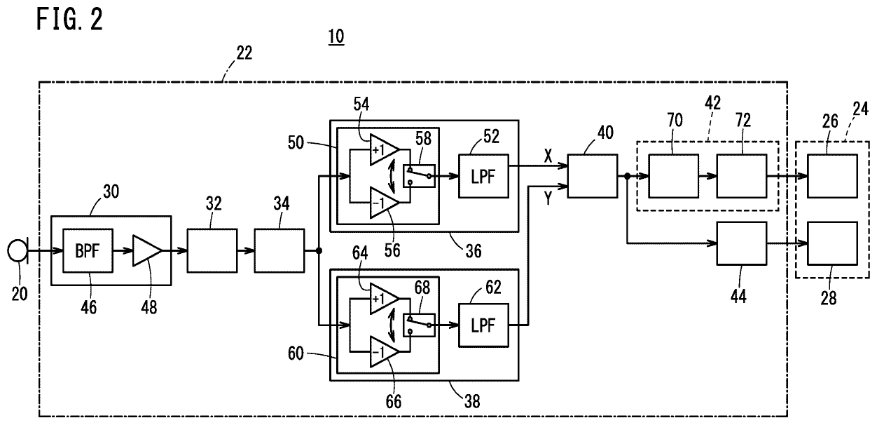

FIG. 2 is a block diagram schematically illustrating the configuration of the leakage detection device 10 along a flow of signal processing. The leakage detection device 10 includes a microphone 20, a circuit board 22, a plurality of circuit components mounted on the circuit board 22, and a notification device 24. In the present embodiment, the notification device 24 includes a vibration device 26 and a plurality of indicator lights 28.

The microphone 20 collects acoustic signals including ultrasonic signals, converts the acoustic signals into electrical signals, and outputs the electrical signals. The microphone 20 can be miniaturized by realizing it with MEMS. The circuit components mounted on the circuit board 22 include a pre-processing circuit 30, a conversion circuit 32, a DC component removal circuit 34, a first lock-in amplifier 36, a second lock-in amplifier 38, a calculation circuit 40, a vibration control circuit 42, and a display control circuit 44.

The pre-processing circuit 30 includes a filter 46 and an amplifier 48. The filter 46 is a band-pass filter (BPF) that extracts components in a predetermined frequency band including the specific frequency F0 from the electric signal output by the microphone 20. In this embodiment, when the specific frequency F0 is 40 kHz, components in a band in the range of, for example, 40 kHz+4 kHz are extracted by the filter 46. The filter 46 removes components in a low frequency band including the audible range and components in a high frequency band.

The filter 46 may be a high-pass filter (HPF) that passes a signal with the specific frequency F0, instead of a band-pass filter. In that case, the components in a low frequency band including the audible range are removed by the high-pass filter.

The amplifier 48 amplifies the components of the predetermined frequency band extracted by the filter 46. It is assumed that the specific frequency F0 is, for example, 40 kHz. The 40 kHz signal tends to have a smaller amplitude value A0 than the other frequency components. Therefore, when the electric signal output from the microphone 20 is amplified by the amplifier 48 without passing through the filter 46, components in the frequency band other than 40 kHz are amplified to a greater extent.

In particular, components in the low frequency band caused by ambient noise or the like in factories do not easily attenuate even when the distance from the sound source is relatively long. Therefore, the amplitude value of the components in the low frequency band can be extremely larger than the amplitude value A0 of the signal at 40 KHz. Due to the amplification of components in the frequency band other than 40 kHz, the amplified signal can be saturated in the range of the supply voltage.

When the signal is saturated, it is not possible to accurately extract the 40 kHz signal through the subsequent signal processing because of the waveform deformation. Therefore, it is preferable that the filter 46 extracts a predetermined frequency band including 40 kHz and removes components in frequency bands other than the predetermined frequency band. The filter 46 removes components in a low frequency band, which are particularly prone to large amplitude values, so that the amplifier 48 can amplify the 40 kHz signal to an appropriate level.

The conversion circuit 32 converts the signal (analog signal) output from the amplifier 48 into a digital signal based on the electrical signal output from the microphone 20. Thus, the signal output from the amplifier 48 can be input to the first lock-in amplifier 36 and the second lock-in amplifier 38 after converted into a digital signal. The sampling rate of the conversion circuit 32 is, for example, 160 ksps. The DC component removal circuit 34 removes the DC offset component generated in the signal conversion process in the conversion circuit 32.

The first lock-in amplifier 36 includes a phase sensitive detector (PSD) 50 and a low-pass filter (LPF) 52. The phase sensitive detector 50 has multiplication circuits 54, 56 and a switch 58. When the switch 58 is connected to the multiplication circuit 54, the multiplication circuit 54 outputs to the switch 58 a digital signal obtained by multiplying by +1 the digital signal from which the DC offset component has been removed. When the switch 58 is connected to the multiplication circuit 56, the multiplication circuit 56 outputs to the switch 58 an inverted signal of the digital signal, the inverted signal being obtained by multiplying the digital signal by −1.

The switch 58 outputs to the low-pass filter 52 either the digital signal coming from the multiplication circuit 54 or the inverted signal coming from the multiplication circuit 56. The switch 58 switches a signal output to the low-pass filter 52 between the digital signal coming from the multiplication circuit 54 and the inverted signal coming from the multiplication circuit 56 at the same period as the period C0 of the signal with the specific frequency F0. The switching operation of the switch 58 enables the phase sensitive detector 50 to switch between the digital signal coming from the output terminal of the DC component removal circuit 34 and its inverted signal at the same period as the period C0 of the signal with the specific frequency F0.

The multiplication circuit 54 may be omitted. In this case, the switch 58 outputs to the low-pass filter 52 either the digital signal coming from the output terminal of the DC component removal circuit 34 or the inverted signal coming from the multiplication circuit 56.

The low-pass filter 52 extracts the DC component from the signal output from the phase sensitive detector 50. Since the switch 58 performs the switching operation at the same period as the period C0 of the signal with the specific frequency F0, the DC component extracted by the low-pass filter 52 corresponds to the signal with the specific frequency F0.

The longer the time constant of the low-pass filter 52 is, the more frequency components other than the specific frequency F0 are removed. However, if the time constant is too long, the user may not be able to follow the movement speed of the leakage detection device 10 when the user moves the leakage detection device 10 while searching for the compressed gas leakage location 16. Therefore, it is necessary to determine an appropriate time constant. In this embodiment, the time constant of the low-pass filter 52 is, for example, 160 ms.

The second lock-in amplifier 38 includes a phase sensitive detector (PSD) 60 and a low-pass filter (LPF) 62. The phase sensitive detector 60 includes multiplication circuits 64, 66 and a switch 68. When the switch 68 is connected to the multiplication circuit 64, the multiplication circuit 64 outputs to the switch 68 a digital signal obtained by multiplying by +1 the digital signal from which the DC offset component has been removed. When the switch 68 is connected to the multiplication circuit 66, the multiplication circuit 66 outputs to the switch 68 an inverted signal of the digital signal, the inverted signal being obtained by multiplying the digital signal by −1.

The switch 68 outputs to the low-pass filter 62 either the digital signal coming from the multiplication circuit 64 or the inverted signal coming from the multiplication circuit 66. The switch 68 switches a signal output to the low-pass filter 62 between the digital signal coming from the multiplication circuit 64 and the inverted signal coming from the multiplication circuit 66 at the same period as the period C0 of the signal with the specific frequency F0. The switching operation of the switch 68 enables the phase sensitive detector 60 to switch between the digital signal coming from the output terminal of the DC component removal circuit 34 and its inverted signal at the same period as the period C0 of the signal with the specific frequency F0.

However, a first phase of the periodic switching between the digital signal and the inverted signal by the phase sensitive detector 60 of the second lock-in amplifier 38 is a phase shifted by 90 degrees (1/4 period) with respect to a second phase of the periodic switching between the digital signal and the inverted signal by the phase sensitive detector 50 of the first lock-in amplifier 36.

The multiplication circuit 64 may be omitted. In this case, the switch 68 outputs to the low-pass filter 62 either the digital signal coming from the output terminal of the DC component removal circuit 34 or the inverted signal coming from the multiplication circuit 66.

The low-pass filter 62 extracts the DC component from the signal output from the phase sensitive detector 60. Since the switch 68 performs the switching operation at the same period as the period C0 of the signal with the specific frequency F0, the DC component extracted by the low-pass filter 62 corresponds to the signal with the specific frequency F0. Similar to the low-pass filter 52, an appropriate time constant needs to be determined as the time constant of the low-pass filter 62. In this embodiment, the time constant of the low-pass filter 62 is, for example, 160 ms.

There is a 90-degree difference between the first phase and the second phase described above. Therefore, there is a 90-degree difference between the phase of the DC component extracted by the low-pass filter 52 of the first lock-in amplifier 36 and the phase of the DC component extracted by the low-pass filter 62 of the second lock-in amplifier 38.

That is, the DC component extracted by the low-pass filter 52 of the first lock-in amplifier 36 corresponds to the cosine component X of the signal with the specific frequency F0. The DC component extracted by the low-pass filter 62 of the second lock-in amplifier 38 corresponds to the sine component Y of the signal with the specific frequency F0.

The calculation circuit 40 calculates a physical quantity corresponding to the amplitude value A0 of the signal with the specific frequency F0. In the present embodiment, the physical quantity calculated by the calculation circuit 40 is the amplitude value A0. In this case, the calculation circuit 40 calculates, as the amplitude value A0 of the signal with the specific frequency F0, the square root of the sum of squares of the cosine component X and the sine component Y of the signal with the specific frequency F0 (A0=√(X²+Y²)). The physical quantity calculated by the calculation circuit 40 should be a physical quantity corresponding to the amplitude value A0 and thus may be, for example, the squared value A02 of the amplitude value or the sound pressure, in addition to the amplitude value A0.

The vibration control circuit 42 and the display control circuit 44 have processing circuits and storage devices (both not shown). The processing circuit includes a processor such as a CPU or a GPU. The storage devices include volatile memory such as RAM and non-volatile memory such as ROM or flash memory. The volatile memory is used as working memory for the processor. The non-volatile memory stores programs executed by the processor and other necessary data.

When the processing circuit is a processor, the processing circuit controls the notification device 24 by executing a program stored in the storage device. The processing circuit may be realized by an integrated circuit such as an ASIC or FPGA, or an electronic circuit including a discrete device.

The processing circuit of the vibration control circuit 42 includes a comparator 70 and a one-shot delay circuit 72. The comparator 70 compares the amplitude value A0 calculated by the calculation circuit 40 with a predetermined threshold value AT. The predetermined threshold AT is defined as an amplitude value of the signal with the specific frequency F0, for example, given when a leakage of 500 ml of gas per minute occurs at a location 30 cm away from the compressed gas leakage location. The predetermined threshold AT is stored in the above-mentioned storage device.

When the comparison by the comparator 70 shows that the amplitude value A0 is larger than the predetermined threshold value AT, the processing circuit causes the vibration device 26 to oscillate for a predetermined time. The predetermined time is a time for which the one-shot delay circuit 72 is maintained in the ON state, and is, for example, 500 ms.

The vibration device 26 is, for example, a vibration motor. When the processing circuit of the vibration control circuit 42 drives the vibration motor, the vibration motor vibrates. The vibration motors vibrates for a predetermined time, whereby the user is notified. The vibrations of the vibration motor are transmitted to a hand of the user who grasps the leakage detection device 10, whereby the user can identify the leakage location 16 of the compressed gas.

The indicator lights 28 are, for example, LED lamps. The processing circuit of the display control circuit 44 controls the lighting of the plurality of LED lamps. The processing circuit of the display control circuit 44 determines which LED lamp will be lit among the plurality of LED lamps according to the amplitude value A0 calculated by the calculation circuit 40. It is set in advance which LED lamps are lit according to the amplitude value A0.

The number of LED lamps lit corresponds to the amplitude value A0. The user is notified by lighting up the number of LED lamps corresponding to the amplitude value A0. A varying number of LED lamps lit allows the user to identify the compressed gas leakage location 16.

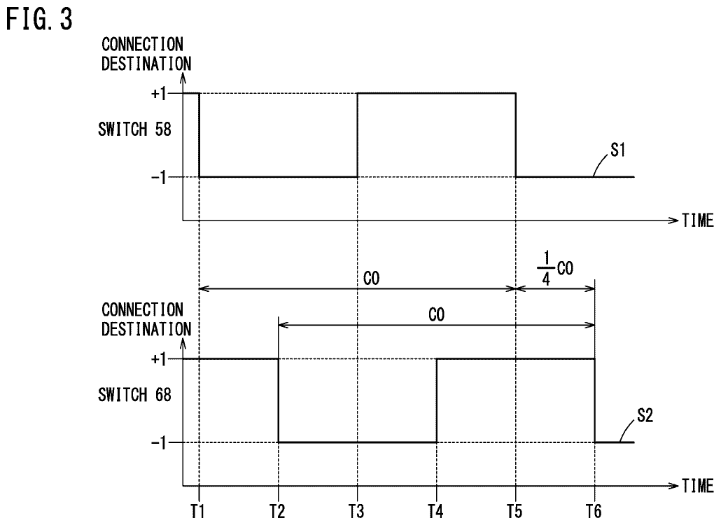

FIG. 3 shows time charts showing switching periods of the switches 58 and 68 of the first and second lock-in amplifiers 36 and 38, respectively. According to a square wave S1 in FIG. 3, the switch 58 periodically switches a signal output to the low-pass filter 52 between the digital signal coming from the +1x multiplication circuit 54 and the inverted signal coming from the −1x multiplication circuit 56. The period of the square wave S1 is equal to the period C0 of the specific frequency F0.

At time T1 shown in FIG. 3, the connection destination of the switch 58 is switched from the output terminal of the +1x multiplication circuit 54 to the output terminal of the −1x multiplication circuit 56. In the period from time T1 to T3, the switch 58 connects to the output terminal of the −1x multiplication circuit 56. At time T3, the connection destination of the switch 58 is switched from the output terminal of the −1x multiplication circuit 56 to the output terminal of the +1x multiplication circuit 54.

In the period from time T3 to T5, the switch 58 connects to the output terminal of the +1x multiplication circuit 54. At time T5, the connection destination of the switch 58 is switched from the output terminal of the +1x multiplication circuit 54 to the output terminal of the −1x multiplication circuit 56.

According to a square wave S2 in FIG. 3, the switch 68 periodically switches a signal output to the low-pass filter 62 between the digital signal coming from the +1x multiplication circuit 64 and the inverted signal coming from the −1x multiplication circuit 66. The period of the square wave S2 is equal to the period C0 of the specific At time T2 shown in FIG. 3, the connection destination of the switch 68 is switched from the output terminal of the +1x multiplication circuit 64 to the output terminal of the −1x multiplication circuit 66. In the period from time T2 to T4, the switch 68 connects to the output terminal of the −1x multiplication circuit 66. At time T4, the connection destination of the switch 68 is switched from the output terminal of the −1x multiplication circuit 66 to the output terminal of the +1x multiplication circuit 64.

In the period from time T4 to T6, the switch 68 connects to the output terminal of the +1x multiplication circuit 64. At time T6, the connection destination of the switch 68 is switched from the output terminal of the +1x multiplication circuit 64 to the output terminal of the −1x multiplication circuit 66.

As described above, the period of the square wave S1 and the period of the square wave S2 are both equal to the period C0 of the specific frequency F0. Also, as shown in FIG. 3, the phase of the square wave S2 is shifted in a direction that lags behind the phase of the square wave S1 by 90 degrees (¼·C0). The phase of the square wave S1 corresponds to the first phase described above, and the phase of the square wave S2 corresponds to the second phase described above. That is, the second phase is shifted in the direction of lagging behind the first phase by 90 degrees (¼·C0).

Accordingly, the cosine component X of the signal with the specific frequency F0 is obtained from the first lock-in amplifier 36, and the sine component Y of the signal with the specific frequency F0 is obtained from the second lock-in amplifier 38. As described above, the amplitude value A0 of the signal with the specific frequency F0 is calculated based on the cosine component X and the sine component Y of the signal with the specific frequency F0.

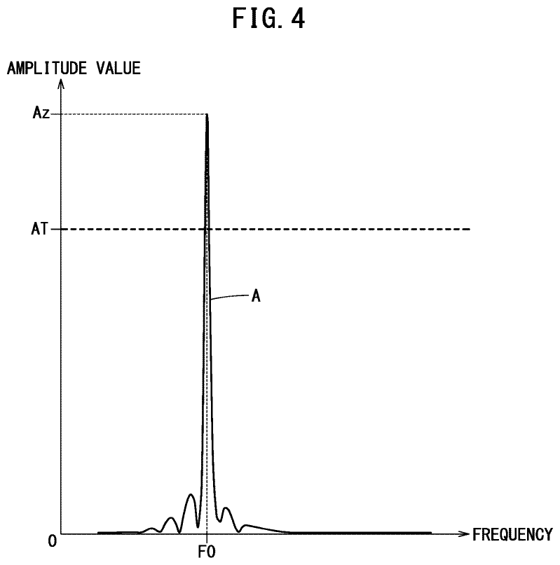

FIG. 4 is a graph illustrating an amplitude value A for each frequency component extracted by each of the first and second lock-in amplifiers 36 and 38. Ideally, only the amplitude value A0 of the signal with a specific frequency F0 should be observed. However, in practice, as shown in FIG. 4, amplitude values of frequencies in the vicinity of the specific frequency F0 are also extracted. One reason is that the square waves S1 and S2 shown in FIG. 3 contain odd harmonics.

However, since the components are extracted by the filter 46 only in the predetermined frequency band including the specific frequency F0, a frequency band where the amplitude value A is observed is narrow and limited as shown in FIG. 4. When the specific frequency F0 is 40 kHz, the frequency band in which the amplitude value A is observed is a band in the range of, for example, 40 kHz +4 KHz. Therefore, the possibility of ambient noise in this narrow frequency band is kept low. Furthermore, the time constants of the low-pass filters 52 and 62, which are placed after the filter 46, are determined to be appropriate values, for example, 160 ms. Therefore, the frequency components extracted by each of the first and second lock-in amplifiers 36 and 38 are limited to an extremely narrow range.

Thus, when the compressed gas is leaking from the pipe 12, the amplitude value Az of the signal with the specific frequency F0 exhibits a significantly higher value and becomes dominant, as illustrated in FIG. 4. Therefore, the amplitude value A0 of the signal with the specific frequency F0 calculated by the calculation circuit 40 can be considered approximately equal to the amplitude value Az of the signal with the specific frequency F0 shown in FIG. 4.

In the example shown in FIG. 4, the amplitude value Az (≈A0) of the signal with the specific frequency F0 exceeds the predetermined threshold AT. The notification device 24 notifies the user in accordance with the amplitude value A0 of the signal with the specific frequency F0 calculated by the calculation circuit 40. Specifically, the vibration device 26 vibrates for a predetermined time. Among a plurality of indicator lights 28, an indicator light 28 corresponding to the amplitude value A0 of the signal with the specific frequency F0 calculated by the calculation circuit 40 is lit.

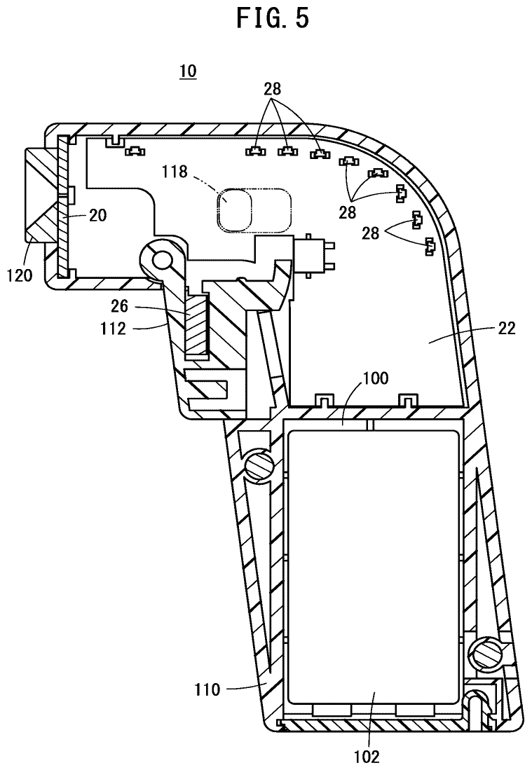

FIG. 5 is a diagram illustrating the overall configuration of the leakage detection device 10. The leakage detection device 10 according to the present embodiment has a housing made of resin with a partially curved shape. As described above with reference to FIG. 2, the leakage detection device 10 includes the microphone 20, the plurality of circuit board 22, the circuit components mounted on the circuit board 22, the vibration device 26, and the plurality of indicator lights 28.

The leakage detection device 10 further includes a battery-accommodating portion 100. FIG. 5 shows a state in which a battery 102 is accommodated in the battery-accommodating portion 100. The voltage of the battery 102 used for the leakage detection device 10 according to the present embodiment is, for example, 9 volts.

The voltage of the battery 102 is extremely small compared to the voltage of a commercial power supply. Therefore, when the amplitude value of the frequency component other than the specific frequency F0 is large, saturation is likely to occur in a small voltage range of the battery 102 when this frequency component is amplified by the amplifier 48. Therefore, as described above, it is preferable that the components in a low frequency band are particularly removed by the filter 46.

When the user grasps the leakage detection device 10, he/she grasps a grip 110 of the housing with his/her hand. The user places one finger (e.g., the index finger) of the hand gripping the grip 110 against a trigger-type switch 112. When the user presses the trigger-type switch 112 with his/her finger, the leakage detection device 10 is energized by the power supply from the battery 102.

When the user releases his/her finger from the trigger-type switch 112, the trigger-type switch 112 returns to its initial position, which is the position before the trigger-type switch 112 was depressed. In this case, the power supply from the battery 102 is stopped. Thus, the power consumption of the battery 102 can be suppressed.

The vibration device 26 is provided on the back side of the trigger-type switch 112. When the user depresses the trigger-type switch 112, the vibration device 26 also moves. When the leakage detection device 10 is in the energized state and the amplitude value A0 of the signal with the specific frequency F0 is larger than the predetermined threshold value AT, the vibration device 26 vibrates for a predetermined time. The vibrations of the vibration device 26 are transmitted to the user's finger that is pressing the trigger-type switch 112. In this way, the notification to the user is performed.

This makes it easier for the user to notice the alarm about the leakage of compressed gas even in a noisy place such as a factory. In addition, because the user can notice the possibility that the compressed gas leakage location 16 exists near the leakage detection device 10, the leakage location 16 can be easily identified.

The leakage detection device 10 illustrated in FIG. 5 has eight indicator lights 28. The eight indicator lights 28 are arranged in a row along the curved portion of the housing. When the user depresses the trigger-type switch 112, the leakage detection device 10 is energized. In this case, power from the battery 102 is supplied to the indicator lights 28 determined by the processing circuit of the display control circuit 44 according to the amplitude value A0 of the signal with the specific frequency F0. The powered indicator lights 28 are lit.

For example, when the amplitude value A0 of the signal with the specific frequency F0 is sufficiently smaller than the predetermined threshold value AT, the 1st to N-th indicator lights 28 among the 1st to 6th indicator lights 28 in order of the arrangement from the end are lit according to the amplitude value A0 (1≤N≤6). The colors of the lights emitted from these six indicator lights 28 are all the same, a first color (e.g., green). When the amplitude value A0 of the signal with the specific frequency F0 is extremely small, all the indicator lights 28 may be turned off.

When the amplitude value A0 exceeds a warning reference value that is smaller than and close to the predetermined threshold AT, the seventh indicator light 28 in the order of arrangement is lit. The color of the light emitted from the seventh indicator light 28 is a second color (e. g., red) different from the first color. When the amplitude value A0 is larger than the predetermined threshold value AT, all the eight indicator lights 28 are lit. The color of the light emitted from the eighth indicator light 28 is the second color as the seventh indicator light 28. In this way, the notification to the user is performed.

The color (second color) of the light emitted from the seventh and eighth indicator lights 28 are different from the color (first color) of the light emitted from the first to sixth indicator lights 28. Therefore, the user can easily notice that the seventh indicator light 28 has been turned on. In this case, the user can notice that the leakage detection device 10 may be close to the compressed gas leakage location 16. Thereafter, the user further moves the leakage detection device 10 and all eight indicator lights 28 are lit, whereby it is known that the leakage detection device 10 has come closer to the leakage location 16. Therefore, the user can easily identify the leakage location 16.

The leakage detection device 10 shown in FIG. 5 is provided with a sliding switch 118 for changing the sensitivity. The user can operate the sliding switch 118 to adjust the attenuation level of the ultrasonic signal given by the attenuator. Thus, the sensitivity of the microphone 20 to the ultrasonic signal can be lowered.

The leakage detection device 10 shown in FIG. 5 is provided with a mounting portion 120 for a nozzle. There is a situation where it is difficult to bring the leakage detection device 10 close to the pipe 12 disposed in a narrow space. However, once a thin nozzle is attached to the mounting portion 120, the thin nozzle can be brought closer to the pipe 12. Thus, the leakage location 16 can be identified even at the pipe 12 disposed in a narrow space.

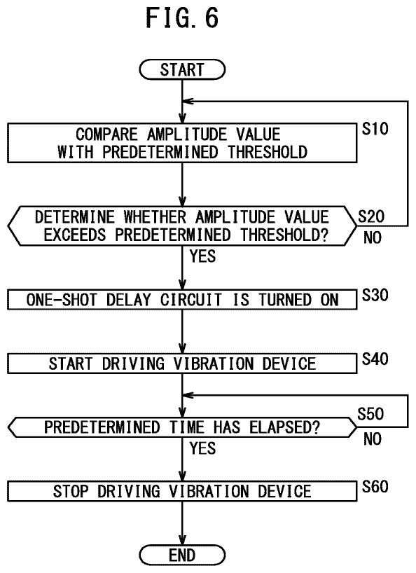

FIG. 6 is a flowchart showing the processing procedure of the vibration control processing performed by the vibration control circuit 42. The processing procedure is performed by the processing circuit of the vibration control circuit 42 executing a program stored in the storage device. When the processing procedure is started, in step S10, the comparator 70 compares the amplitude value A0 of the signal with the specific frequency F0 calculated by the calculation circuit 40 with the predetermined threshold AT.

In step S20, the processing circuit determines whether the amplitude value A0 has exceeded the predetermined threshold AT, based on the result of the comparison by the comparator 70. In the case of YES in step S20, the procedure proceeds to step S30. In the case of NO in step S20, the processing procedure returns to step S10. In step S30, the processing circuit turns on the one-shot delay circuit 72. In step S40, the processing circuit starts driving the vibration device 26. The vibration device 26 starts to oscillate.

In step S50, the processing circuit determines whether a predetermined time has elapsed since the vibration device 26 started to vibrate. While the one-shot delay circuit 72 is in the ON state, the predetermined time has not yet elapsed. When the predetermined time has elapsed, the one-shot delay circuit 72 is switched from the ON state to the OFF state. At this time, the processing circuit determines that a predetermined time has elapsed since the vibration device 26 started to vibrate. In the case of YES in step S50, the procedure proceeds to step S60. In the case of NO in step S50, the processing procedure repeats the processing in step S50.

In step S60, the processing circuit stops driving the vibration device 26. Even if the amplitude value A0 has stayed above the predetermined threshold AT up to this point, the vibrations of the vibration device 26 stop. Thus, the power consumption of the battery 102 can be suppressed. When the processing of step S60 is completed, the present processing procedure ends.

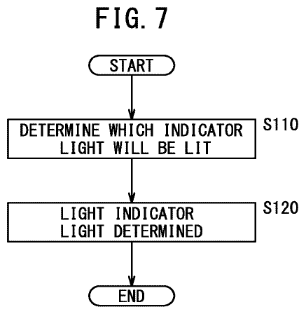

FIG. 7 is a flowchart showing the processing procedure of the display control process performed by the display control circuit 44. The processing procedure is performed by the processing circuit of the display control circuit 44 executing a program stored in the storage device. When the processing procedure starts, in step S110, the processing circuit determines which indicator light 28 will be lit among the plurality of indicator lights 28 according to the amplitude value A0 of the signal with the specific frequency F0 calculated by the calculation circuit 40. In step S120, the processing circuit lights the determined indicator light 28. When the processing of step S120 is completed, the present processing procedure ends.

### Modified Example

The above embodiment may be modified as follows.

In the above embodiment, digital signals are input to the first and second lock-in amplifiers 36 and 38. That is, the first and second lock-in amplifiers 36 and 38 are digital lock-in amplifiers.

However, the first and second lock-in amplifiers 36 and 38 may be analog lock-in amplifiers. In that case, the conversion circuit 32 and the DC component removal circuit 34 are not used. The signals (analog signals) output from the amplifier 48 based on the electrical signals output from the microphone 20 are input to the first lock-in amplifier 36 and the second lock-in amplifier 38.

### Invention Derived from Embodiments

The invention that can be understood from the above embodiment and the modified examples will be described below.
(1) A leakage detection device (10) for detecting leakage of compressed gas includes a microphone (20) that collects an ultrasonic signal, converts the ultrasonic signal into an electric signal, and outputs the electric signal, a lock-in amplifier (36, 38) that extracts a signal (X, Y) with a specific frequency (F0) corresponding to the leakage, based on the electric signal, a calculation circuit (40) that calculates a physical quantity corresponding to an amplitude value (A0) of the signal with the specific frequency, and a notification device (24) that notifies a user in accordance with the physical quantity calculated by the calculation circuit. As a result, the user can locate the compressed gas leakage location more easily.
(2) The lock-in amplifier may include a phase sensitive detector (50, 60) and a first filter (52, 62), the phase sensitive detector may output one signal that is either the electric signal or an inverted signal of the electric signal, by switching between the electric signal and the inverted signal in accordance with a period (C0) of the signal with the specific frequency, and the first filter may be a low-pass filter that extracts the signal with the specific frequency by extracting a DC component of an output signal coming from the phase sensitive detectors. As a result, a signal with a specific frequency can be extracted with high accuracy.
(3) The lock-in amplifier may include a first lock-in amplifier (36) and a second lock-in amplifier (38), the phase sensitive detector of the first lock-in amplifier may output the one signal by switching between the electric signal and the inverted signal at the same period as the signal with the specific frequency, the phase sensitive detector of the second lock-in amplifier may output the one signal by switching between the electric signal and the inverted signal at the same period as the signal with the specific frequency, the first phase for periodic switching between the electric signal and the inverted signal by the phase sensitive detector of the second lock-in amplifier is a phase shifted by 90 degrees with respect to a second phase for periodic switching between the electric signal and the inverted signal by the phase sensitive detector of the first lock-in amplifier, and the calculation circuit may calculate the physical quantity of the signal with the specific frequency based on the signal with the specific frequency extracted by the first filter of the first lock-in amplifier and the signal with the specific frequency extracted by the first filter of the second lock-in amplifier. As a result, a signal with a specific frequency can be extracted easily.
(4) The leakage detection device may further include a second filter (46) that extracts a component of a predetermined frequency band including the specific frequency from the electrical signal output by the microphone, and an amplifier (48) that amplifies the component of the predetermined frequency band, wherein the lock-in amplifier may extract the signal with the specific frequency based on the component of the predetermined frequency band amplified by the amplifier. As a result, a weak signal with a specific frequency can be separated and extracted from relatively large ambient noises.
(5) The leakage detection device may further include a battery accommodating portion (100) that is configured to accommodate a battery (102), wherein the leakage detection device may be portable. As a result, the compressed gas leakage location can be identified without being affected by the length of a power feeding cable.
(6) The leakage detection device may further include a comparator (70) that compares the physical quantity with a predetermined threshold (AT), wherein the notification device may be a vibration device (26), and when the physical quantity is larger than the predetermined threshold (AT), the vibration device may perform notify the user by vibrating for a predetermined time. As a result, the user can easily notice the notification about the leakage of compressed gas.
(7) In the leakage detection device, the notification device may be a plurality of indicator lights (28), and the plurality of indicator lights may notify the user by lighting at least some indicator lights corresponding to the physical quantity among the plurality of indicator lights.

As a result, the user can easily notice that the leakage detection device is approaching the compressed gas leakage location while grasping and moving the leakage detection device.

The present invention is not limited to the above-described disclosure, and various configurations can be adopted without departing from the scope of the present invention.

1. A leakage detection device for detecting leakage of compressed gas, comprising:
a microphone that collects an ultrasonic signal, converts the ultrasonic signal into an electric signal, and outputs the electric signal;
a lock-in amplifier that extracts a signal with a specific frequency corresponding to the leakage, based on the electric signal;
a calculation circuit that calculates a physical quantity corresponding to an amplitude value of the signal with the specific frequency; and
a notification device that notifies a user in accordance with the physical quantity calculated by the calculation circuit.

2. The leakage detection device according to claim 1, wherein
the lock-in amplifier includes a phase sensitive detector and a first filter,
the phase sensitive detector outputs one signal that is either the electric signal or an inverted signal of the electric signal, by switching between the electric signal and the inverted signal in accordance with a period of the signal with the specific frequency, and
the first filter is a low-pass filter that extracts the signal with the specific frequency by extracting a DC component of an output signal coming from the phase sensitive detector.

3. The leakage detection device according to claim 2, wherein
the lock-in amplifier includes a first lock-in amplifier and a second lock-in amplifier,
the phase sensitive detector of the first lock-in amplifier outputs the one signal by switching between the electric signal and the inverted signal at a same period as the signal with the specific frequency,
the phase sensitive detector of the second lock-in amplifier outputs the one signal by switching between the electric signal and the inverted signal at the same period as the signal with the specific frequency,
a first phase for periodic switching between the electric signal and the inverted signal by the phase sensitive detector of the second lock-in amplifier is a phase shifted by 90 degrees with respect to a second phase for periodic switching between the electric signal and the inverted signal by the phase sensitive detector of the first lock-in amplifier, and
the calculation circuit calculates the physical quantity of the signal with the specific frequency based on the signal with the specific frequency extracted by the first filter of the first lock-in amplifier and the signal with the specific frequency extracted by the first filter of the second lock-in amplifier.

4. The leakage detection device according to claim 1, further comprising:
a second filter that extracts a component of a predetermined frequency band including the specific frequency from the electric signal output by the microphone; and
an amplifier that amplifies the component of the predetermined frequency band,
wherein the lock-in amplifier extracts the signal with the specific frequency based on the component of the predetermined frequency band amplified by the amplifier.

5. The leakage detection device according to claim 4, further comprising
a battery accommodating portion that is configured to accommodate a battery,
wherein the leakage detection device is portable.

6. The leakage detection device according to claim 1, further comprising
a comparator that compares the physical quantity with a predetermined threshold,
wherein
the notification device is a vibration device, and
in a case where the physical quantity is larger than the predetermined threshold, the vibration device notifies the user by vibrating for a predetermined time.

7. The leakage detection device according to claim 1, wherein
the notification device is a plurality of indicator lights, and
the plurality of indicator lights notify the user by lighting up at least some indicator lights corresponding to the physical quantity among the plurality of indicator lights.
